(19) United States
(12) Patent Application Publication
(10) Pub. No.: US 2026/0054373 A1
(43) Pub. Date: Feb. 26, 2026

(54) WEARABLE SENSOR SYSTEMS AND ALGORITHMS FOR REMOTE MONITORING

(71) Applicant: VANDERBILT UNIVERSITY, Nashville, TN (US)

(72) Inventors: Karl E. Zelik, Nashville, TN (US); Cameron Nurse, Nashville, TN (US); Katherine Rodzak, Nashville, TN (US)

(21) Appl. No.: 19/352,574

(22) Filed: Oct. 8, 2025

Related U.S. Application Data
(63) Continuation-in-part of application No. 18/017,877, filed on Jan. 25, 2023.
(60) Provisional application No. 63/706,960, filed on Oct. 14, 2024.

(51) Int. Cl. B25J 9/00; B25J 13/04; B25J 13/08

(52) U.S. Cl. CPC B25J 9/0006; B25J 13/04; B25J 13/085; B25J 13/087; B25J 13/088

(57) ABSTRACT

The invention relates to method and system for monitoring musculoskeletal loading of a user during remote or longitudinal activity. The method includes collecting, by a primary sensor device operably attached to the user, primary sensor data indicative of biomechanical loading of a musculoskeletal tissue; collecting, by a secondary sensor device operably attached to the user, secondary sensor data indicative of physical activity of the user; synchronizing the primary sensor data with the secondary sensor data over a training interval; training, using the synchronized primary and secondary sensor data, a calibration model specific to the user to estimate a musculoskeletal loading metric from the secondary sensor data; and estimating, by applying the calibration model, the musculoskeletal loading metric during a period in which only the secondary sensor data is available.

### CROSS-REFERENCE TO RELATED PATENT APPLICATIONS

This application claims priority to and the benefit of U.S. Provisional Patent Application Ser. No. 63/706,960, filed Oct. 14, 2024, which are incorporated herein by reference in their entireties.

This application is also a continuation-in-part application of U.S. patent application Ser. No. 18/017,877, filed Jan. 25, 2023, which is a national stage entry of PCT Patent Application Serial No. PCT/US2021/043631, filed Jul. 29, 2021, which itself claims priority to and the benefit of U.S. Provisional Patent Application Ser. Nos. 63/058,066, filed Jul. 29, 2020, and 63/124,961, filed Dec. 14, 2020, which are incorporated herein by reference in their entireties.

### STATEMENT AS TO RIGHTS UNDER FEDERALLY-SPONSORED RESEARCH

This invention was made with government support under AR080708 awarded by the National Institutes of Health. The government has certain rights in the invention.

### FIELD OF THE INVENTION

This invention relates generally to wearable sensing devices and to methods and systems for monitoring musculoskeletal loading or other biomechanical metrics using multiple wearable sensors and calibration algorithms.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Musculoskeletal injuries such as tibial fractures represent a significant clinical challenge, often requiring surgical fixation followed by prolonged rehabilitation. Recovery outcomes depend heavily on how well musculoskeletal tissues are progressively loaded during daily activities, since sufficient loading stimulates bone remodeling pathways and functional recovery. However, clinicians currently lack reliable tools to assess how patients load their musculoskeletal system outside of infrequent clinical visits.

Wearable pressure-sensing insoles have been used to measure ground reaction forces and estimate bone loading and other biomechanical and musculoskeletal metrics with good accuracy. While effective in controlled or laboratory settings, these devices are impractical for continuous daily use. Studies show that patients typically wear insoles for only 4-5 hours per day, leaving the majority of daily physical activity unmonitored. This limited wear time introduces substantial variability in data collection and hampers the ability to assess cumulative daily loading or to compare loading patterns across multiple days.

Consumer-grade fitness trackers and smartwatches are widely adopted and demonstrate high daily compliance, often exceeding 90% wear time. These devices, and other similar sensing devices (e.g., smart rings), can capture high-level physical activity metrics such as step count, activity level, heart rate, and movement intensity. However, they do not directly measure musculoskeletal loads and cannot provide accurate estimates of internal tissue forces such as tibial bone loading, calf muscle force, or Achilles tendon loading.

Prior research has demonstrated the potential to fuse data from wearable insoles and inertial sensors through biomechanical models or machine learning techniques. While promising, these approaches still rely on continuous insole use and therefore remain limited by the same compliance and wear time challenges. To date, no practical solution has been provided to compensate for variable insole wear time while still enabling accurate estimation of musculoskeletal loading across an entire day.

Conventional wearable systems such as pressure-sensing insoles provide accurate biomechanical data but suffer from limited wear time, while consumer wearables (e.g., fitness trackers) offer long wear times but cannot directly measure internal musculoskeletal loads. As a result, clinicians and researchers lack reliable tools for continuous, real-world monitoring of patient loading patterns and other musculoskeletal dynamics, particularly during rehabilitation from injuries such as tibial fractures.

Therefore, a heretofore unaddressed need exists in the art to address the aforementioned deficiencies and inadequacies.

### SUMMARY OF THE INVENTION

One of the objectives of this invention is to address the shortcomings by integrating a primary sensor device that provides direct but time-limited biomechanical measurements with a secondary sensor device that provides indirect but long-duration physical activity data. A processing unit synchronizes data from the primary and secondary sensor devices and trains a calibration model, which may be user-specific, to estimate a musculoskeletal loading metric (or other musculoskeletal dynamics metrics) from secondary sensor data when primary data are unavailable. This dual-sensor framework compensates for incomplete wear time of the primary sensor device, thereby enabling more complete, consistent, and accurate estimates of musculoskeletal loading across extended periods. By applying a user-specific calibration model, tibial bone loading stimulus can be estimated with less than 10% error even when insoles are worn for only 25% of the day. Additional embodiments include real-time or delayed feedback to the user, machine learning-based estimation models, integration with communication devices, additional tissue loading or musculoskeletal dynamics metrics, and use in clinical rehabilitation, sports performance monitoring, and ergonomic assessment.

The invention thus enables clinicians and researchers to remotely and/or portably monitor musculoskeletal loading conditions in daily life, personalize rehabilitation programs, and improve patient outcomes, while also reducing the burden of continuous use of specialized biomechanical sensors.

In one aspect, the invention relates to a method for monitoring musculoskeletal loading of a user during remote or longitudinal activity. The method includes collecting and/or computing, by a primary sensor device operably attached to the user, primary sensor data indicative of biomechanical loading of a musculoskeletal tissue; collecting and/or computing, by a secondary sensor device operably attached to the user, secondary sensor data indicative of physical activity of the user; synchronizing the primary sensor data with the secondary sensor data over a training interval; training, using the synchronized primary and secondary sensor data, a calibration model specific to the user to estimate a musculoskeletal loading metric from the secondary sensor data; and estimating, by applying the calibration model, the musculoskeletal loading metric during a period in which only the secondary sensor data is available.

In one embodiment, the primary sensor device comprises at least one of a pressure-sensing insole and a force sensor configured to measure ground reaction forces or the force between the wearer's foot and their footwear.

In one embodiment, the primary sensor device further comprises at least one inertial measurement unit (IMU).

In one embodiment, the primary sensor device further comprises at least one IMU, accelerometer, gyroscope, or other motion sensor configured to estimate user kinematics and/or to use in combination with data from the at least one pressure-sensing insole or force sensor to estimate musculoskeletal loading.

In one embodiment, the secondary sensor device comprises at least one fitness tracker or other wearable sensing device configured to measure at least one of step count, activity time, activity level, accelerometry, angular velocity, heart rate, and/or motion intensity.

In one embodiment, said synchronizing the primary sensor data with the secondary sensor data comprises wirelessly collecting data with timestamp from the primary and secondary sensor devices and aligning the timestamped data streams in time.

In another embodiment, synchronizing the primary sensor data with the secondary sensor data is achieved by extracting epoch-based step count or motion intensity metrics from both the primary sensor data and secondary sensor data, then using cross correlation or other convolutional or correlational methods to align the timing.

In one embodiment, said training comprises applying a machine learning algorithm including LASSO (least absolute shrinkage and selection operator) regression, gradient boosted trees, neural networks, and/or support vector machines.

In one embodiment, said estimating further comprises supplementing missing primary sensor data with estimated metrics derived from the secondary sensor device.

In one embodiment, the calibration model is a user-specific calibration model that is built based on the synchronized primary and secondary sensor data.

In one embodiment, the calibration model is a non-user-specific calibration model that is built based on the synchronized primary and secondary sensor data from one or more other users.

In one embodiment, the calibration model is retrained periodically using new synchronized primary and secondary data collected during subsequent use, by the user or other users.

In one embodiment, the musculoskeletal loading metric comprises a tibial bone force or a tibial bone loading stimulus computed as a function of time-integrated tissue force raised to an exponent.

In one embodiment, the musculoskeletal loading metric comprises an ankle moment, Achilles tendon force, calf muscle force, tibial force, or other musculoskeletal metric associated with ankle plantarflexor muscle contraction.

In one embodiment, the tibial bone loading stimulus is estimated with less than 10% error when the pressure insoles are worn for at least 25% of a user's daily waking time.

In one embodiment, the method further comprises providing user feedback through an audio, visual, and/or haptic interface in real time when the musculoskeletal loading metric exceeds a predetermined threshold.

In one embodiment, the method further comprises computing a daily loading stimulus by summing estimated loading stimuli across a plurality of intervals of a day, which represents a cumulative musculoskeletal loading measure.

In another aspect, the invention relates to a wearable sensor system for monitoring musculoskeletal loading of a user. The system comprises a primary sensor device comprising one or more sensors operably attached to a first location of the user, the primary sensor device configured to generate primary sensor data indicative of biomechanical loading of a musculoskeletal tissue; a secondary sensor device comprising one or more sensors operably attached to a second location of the user, the secondary sensor device configured to generate secondary sensor data indicative of physical activity of the user; and at least one processing unit in communication with the primary and secondary sensor devices, the processing unit configured to synchronize the primary sensor data with the secondary sensor data; train a calibration model using the synchronized primary and secondary sensor data to estimate a musculoskeletal loading metric from the secondary sensor data; and apply the calibration model to estimate the musculoskeletal loading metric during periods in which only the secondary sensor device provides data.

In one embodiment, the primary sensor device comprises at least one of a pressure-sensing insole and a force-sensing insole configured to measure ground contact forces or the force between the wearer's foot and their footwear.

In one embodiment, the primary sensor device further comprises at least one inertial measurement unit (IMU).

In one embodiment, the primary sensor device further comprises strain gauges, force sensors, motion sensors, electromyography (EMG) electrodes, or sensors integrated into exoskeletons (including exosuits) or smart clothing.

In one embodiment, the first location of the user includes the foot, shank, or other musculoskeletal segments of the user.

In one embodiment, the secondary sensor device comprises at least one fitness tracker including at least one of an inertial measurement unit (IMU), an accelerometer, a gyroscope, a heart rate sensor, a temperature sensor, or a global positioning system (GPS) unit.

In one embodiment, the fitness tracker is configured to measure at least one of step count, activity time, activity level, accelerometry, heart rate, and/or motion intensity.

In one embodiment, the secondary sensor device comprises a smartphone carried in a pocket, a smartwatch, a ring-style tracker, and/or sensors integrated into clothing or exoskeletons.

In one embodiment, the secondary sensor device is configured for continuous wear exceeding 90% of the user's daily activity time.

In one embodiment, the primary sensor device and the secondary sensor device are integrated into at least one of an insole, footwear, a smartwatch, a smartphone, smart clothing, and an exoskeleton.

In one embodiment, the calibration model is a user-specific calibration model that is built based on the synchronized primary and secondary sensor data. In another embodiment, the calibration model is a non-user-specific calibration model built based on the synchronized primary and secondary sensor data from one or more other users.

In one embodiment, the calibration model comprises a machine learning algorithm including regression models, decision tree models, neural networks, and/or support vector machines.

In one embodiment, the processing unit is further configured to estimate a daily tibial bone loading stimulus with less than 10% error when the insoles are worn for at least 25% of a user's daily waking time.

In one embodiment, the processing unit is further configured to provide user feedback via an audio, visual, or haptic interface when the musculoskeletal loading metric exceeds a predetermined threshold.

In one embodiment, the processing unit is further configured to compute a daily loading stimulus by summing estimated loading stimuli across a plurality of time intervals, which represents a cumulative musculoskeletal loading measure.

In one embodiment, the processing unit is further configured to store user-specific demographic, physiological, clinical, or user-provided data to refine the calibration model.

In one embodiment, the system further comprises a wireless communication interface for transmitting the estimated musculoskeletal loading metrics to a remote device.

In a further aspect, the invention relates to a non-transitory tangible computer-readable storage medium storing instructions that, when executed by a processing unit, cause the processing unit to perform the method for monitoring musculoskeletal loading of a user during remote or longitudinal activity as disclosed above.

These and other aspects of the invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 shows schematically a signal flow chart for loading stimulus (LS) estimation models. This shows how signals were processed to compute tibial LS estimates from the fitness tracker. Orange represents data from the insole and blue represents data from the fitness tracker.

FIG. 2 shows schematically a signal flow diagram for a given day. When insole data are collected, both insole and fitness tracker data are used to build a user-specific calibration model for that day. When insole data are not available, fitness tracker inputs are processed through a generic model first, then the calibration model that was built is applied (dashed line) to estimate the calibrated loading stimulus (LS). The daily loading stimulus (DLS) is calculated by combining LS estimates from the insole, when available, with LS estimates from the fitness tracker when insole data are absent, then applying Eqn 5.

FIG. 3 shows loading stimulus (LS) computed from the insole vs. (A) generic and (B) calibrated fitness tracker LS estimates. Each color represents a different participant, and each data point a different minute of the data collection. The black line represents the perfect relationship between fitness tracker and insole LS estimates.

FIG. 4 shows the percentage of insole data used vs. the user-specific error in DLS estimates during simulated days. Errors in DLS are computed relative to the best-case scenario in which insoles are worn 100% of the day. Each color is the average trendline for an individual participant. The thicker black line represents the inter-participant average.

FIG. 5 shows the percentage of insole data used vs. the average error in DLS estimates during simulated days when applying the generic model vs. the generic and calibrated model. Errors in DLS are computed relative to the best-case scenario in which insoles are worn 100% of the day. Each line represents the average across all participants.

FIG. 6 shows schematically a flowchart of an algorithm for generic plus user-specific model.

FIG. 7 shows schematically a flowchart of an algorithm for user-specific model only.

FIG. 8 shows schematically a flowchart of an algorithm for classifier with look-up table.

FIG. 9 shows schematically a flowchart of an algorithm for hybrid approach.

### DETAILED DESCRIPTION OF THE INVENTION

The invention will now be described more fully hereinafter with reference to the accompanying drawings, in which exemplary embodiments of the invention are shown. The invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the terms “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used in this invention, the phrase “at least one of A, B, and C” should be construed to mean a logical (A or B or C), using a non-exclusive logical OR. As used herein, the term “and/or” includes any and all combinations of one or more of the associated listed items.

The apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

In view of the foregoing, there remains a need for improved methods and systems that provide accurate and non-invasive estimates of musculoskeletal loading, account for limited or inconsistent use of primary biomechanical sensors, leverage long-duration data streams from secondary wearable devices such as fitness trackers, and deliver complete and comparable daily and longitudinal loading estimates suitable for clinical rehabilitation, sports, or ergonomic monitoring. The term musculoskeletal loading is used broadly throughout to signify any biomechanical or musculoskeletal dynamics metric or metrics, such as force, torque, stress, strain, work, power, damage, or stimulus.

This invention provides methods and systems for remote monitoring of musculoskeletal loading or other biomechanical metrics using a combination of a dual-sensor framework to address the need. The dual-sensor framework integrates a primary sensor device capable of directly measuring or estimating loading with a secondary sensor device capable of more extended or continuous wear, combined through user-specific or other trained calibration models to yield accurate estimates of musculoskeletal metrics even when the primary sensors are worn intermittently. By synchronizing both devices and using machine learning models including one or more user-specific or trained calibration models, the invention fills gaps in monitoring caused by limited wear time of primary sensors, providing accurate estimates of tibial or other musculoskeletal loading across full days or prolonged monitoring periods.

The primary sensor device directly measures or estimates the biomechanical metric of interest but is typically worn for only limited periods of time. The secondary sensor device does not directly measure the biomechanical metric but is wearable for extended durations, thereby providing continuous activity data. By synchronizing data from both systems and training a calibration model, the invention enables accurate estimation of musculoskeletal loading during periods when only the secondary system is worn.

The primary sensor device may comprise one or more sensors on one or more locations on the user's body. The secondary sensor device may also comprise one or more sensors on one or more locations on the user's body.

In one embodiment, the primary sensor device comprises one or more force sensors or pressure-sensing insoles, each configured to measure in-shoe forces and/or ground reaction forces. The primary sensor device may further include inertial measurement units (IMUs) for detecting acceleration and/or angular velocity. Data from the insoles are processed to compute musculoskeletal loading metrics such as tibial bone compression forces, Achilles tendon force, ankle moment, or other kinematic and kinetic metrics related to the user's joints or body segments. It should be noted that the ground reaction force describes the force between the bottom of the shoe and the ground, while the in-shoe forces describe the forces between the foot and shoe. These two metrics tend to be highly correlated, but they are not exactly the same. For instance, if one tied their shoe really tightly the in-shoe force would increase but the ground reaction force would not. The system covers both embodiments, for instance, a shoe with a pressure-sensing insole inside as well as a shoe with force sensors or a pressure-sensing outsole on the very bottom of the shoe.

In other embodiments, the primary sensor device may include additional or alternative sensors, such as strain gauges, force sensors, motion sensors, electromyography (EMG) electrodes, or sensors integrated into exoskeletons or smart clothing. The primary sensor device may be operably attached to a predetermined body location including the foot, shank, or other body segments.

In one embodiment, the secondary sensor device comprises a fitness tracker or activity tracker worn on the wrist or hand. The fitness tracker may include an IMU, accelerometer, gyroscope, heart rate monitor, global positioning system (GPS) receiver, temperature sensor, or combinations thereof. The fitness tracker provides high-level activity metrics including step count, activity time, activity level, heart rate, or motion intensity.

In other embodiments, the secondary sensor device may comprise a smartphone carried in a pocket, a smartwatch, a ring-style tracker, or sensors integrated into clothing or exoskeletons. The secondary sensor device may be worn continuously throughout a user's daily activities, achieving wear times greater than 90% of waking hours.

In some embodiments, the primary sensor device is located below the waist of the user, and the secondary sensor device is located on or above the waist of the user. In other embodiments, the primary sensor device and secondary device are both located either above or below the waist of the user.

In some embodiments, the primary sensor device and secondary sensor device are collocated, with primary sensor device configured to be used (e.g., turned on, collecting data) for a shorter time period and with the secondary sensor device configured to be used continuously or for a longer time period.

The system also includes a processing unit, implemented in hardware, software, or a combination thereof, configured to receive and process data from the primary and secondary sensor devices. Data streams are synchronized to a common timeline to enable training of calibration models.

In one embodiment, the processing unit executes a machine learning algorithm trained with the synchronized primary and secondary data. Suitable algorithms include, but are not limited to, regression models (e.g., LASSO regression), gradient boosted trees, neural networks, and support vector machines. In some embodiments, lookup tables or hybrid classifiers may be employed.

The calibration model may be user-specific, such that data collected while both primary and secondary sensors are worn is used to adapt the model to an individual's movement patterns. This user-specific calibration accounts for individual variability such as arm swing, gait style, or activity intensity. Once trained, the model is applied to secondary sensor data alone to estimate musculoskeletal loading during periods when the primary sensor device is not worn or not collecting data.

In one embodiment, the processing unit estimates a tibial bone loading stimulus (LS), which represents the cumulative loading experienced by the tibia on a minute-by-minute basis. LS may be derived as a non-linear function of tibial force raised to an empirically determined exponent.

From LS, a daily loading stimulus (DLS) can be computed by summing across intervals of a day, thereby capturing the cumulative loading stimulus experienced by the bone over time. Clinical studies indicate that DLS is a key determinant of musculoskeletal remodeling and recovery following fracture. The same approach can be applied to other musculoskeletal structures such as muscles, tendons, ligaments, joints, or bones beyond the tibia.

In one exemplary implementation, the invention achieves estimation of DLS with less than 10% error when the primary insoles are worn for only 25% of a day (e.g., ˜2.5 hours in a 10-hour waking period), with the secondary sensor device providing continuous coverage.

In some embodiments, the processing unit provides real-time or delayed feedback to the user or a clinician or other stakeholder. Feedback may be delivered via audio tones, visual indicators, haptic vibrations, or alerts on a connected smartphone, smartwatch, or other wearable. The system may notify a user if loading falls below a minimum therapeutic threshold, exceeds a safe maximum threshold, or deviates from a prescribed rehabilitation program.

The system may further transmit musculoskeletal loading estimates to a remote server or cloud platform for storage, analysis, and clinical review. Data may be accessible through user interfaces including computers, tablets, or mobile devices.

The invention may be implemented in combination with additional wearable devices such as exoskeletons, exosuits, or smart clothing to provide augmented monitoring or assistance. The system may also incorporate physiological sensors (e.g., heart rate variability, oxygen saturation, sleep monitors) to improve predictive models of tissue recovery, remodeling, or injury risk.

In some embodiments, the processing unit implements a classifier such as a state machine to identify user activities (e.g., walking, running, sitting, or rehabilitation exercises), applying different estimation algorithms depending on activity state.

The algorithms may be executed in real time for immediate feedback or at a later time for retrospective analysis. Data may be stored locally or transmitted wirelessly to external devices for further processing.

In one exemplary scenario, a patient recovering from tibial shaft fracture surgery wears pressure-sensing insoles for approximately 3 hours each day during normal activity, in addition to a wrist-worn fitness tracker worn continuously. The calibration model is trained using the periods of overlap when both systems are worn. For the remaining hours, tibial loading stimulus is estimated from the fitness tracker data alone. Daily loading stimulus is computed and transmitted to the patient's clinician, who uses the information to adjust the rehabilitation plan and guide recovery. A calibration model from one day may also be used to estimate tibial loading stimulus from the fitness tracker data alone one or more separate days.

According to the invention, the method and the wearable sensor system are capable of non-invasively measuring or estimating loads on tissues inside the body or other biomechanical metrics (e.g., kinematics, kinetics). The method involves training a secondary sensor device to estimate the metric of interest based on data and metrics computed from a primary sensor device, wherein the primary sensor device is worn (or used, e.g., collecting data) for a shorter period of time and the secondary sensor device is worn (or used) for a longer period of time. In effect, the secondary sensor device can fill gaps in the estimates of the primary sensor device, or be used to provide additional estimates for the purpose of validation of corroboration.

Specifically, the method includes collecting, by a primary sensor device operably attached to the user, primary sensor data indicative of biomechanical loading of one or more musculoskeletal tissues; collecting, by a secondary sensor device operably attached to the user, secondary sensor data indicative of physical activity of the user; synchronizing the primary sensor data with the secondary sensor data over a training interval; training, using the synchronized primary and secondary sensor data, a calibration model (e.g., specific to the user) to estimate a musculoskeletal loading metric from the secondary sensor data; and estimating, by applying the calibration model, the musculoskeletal loading metric during a period in which only the secondary sensor data is available.

In some embodiments, there can be one training interval. In other embodiments there can be more than one training interval. In some embodiments, the one or more training intervals are on the same day. In other some embodiments, the one or more training intervals are on different days. Training intervals may be recurring at a regular frequency or sporadic such that the calibration model is dynamic or changes over time. Sensor data used for training and calibration model creation may be from one or more users.

The wearable sensor system comprises a primary sensor device comprising one or more sensors operably attached to a first location of the user, the primary sensor device configured to generate primary sensor data indicative of biomechanical loading of a musculoskeletal tissue; a secondary sensor device comprising one or more sensors operably attached to a second location of the user, the secondary sensor device configured to generate secondary sensor data indicative of physical activity of the user; and at least one processing unit in communication with the primary and secondary sensor devices, the processing unit configured to synchronize the primary sensor data with the secondary sensor data; train a calibration model using the synchronized primary and secondary sensor data to estimate a musculoskeletal loading metric from the secondary sensor data; and apply the calibration model to estimate the musculoskeletal loading metric during periods in which only the secondary sensor device provides data.

In some embodiments the second location of the user is the same as, close to, or connected to the first location of the user.

In some embodiments, the first sensor device and/or second sensor device is distributed over more than one location of the user. For example, the first sensor device may be comprised of two pressure-sensing insoles, one under each foot. Or, for example, the second sensor device may be comprised of a wrist-worn fitness tracker, smart ring, and smart glasses. In some embodiments, the first or second sensor device may comprise sensors inside of the user's phone.

In implementation, each of the primary and secondary sensor devices is attached at a predetermined location on the user and configured to detect information about a biomechanical activity of the musculoskeletal system. The primary sensor device can measure or estimate the metric of interest but is only practical to wear (or use) for a limited period of time. Nominally, the secondary sensor device cannot measure or directly estimate the metric of interest but can be worn for a longer period of time. The secondary sensor device is configured to collect data synchronously with the primary sensor device. These synchronous data are used to train the secondary sensor device to estimate the metric for a specific user or set of activities, after which the secondary sensor device may be used to fill in gaps left by the primary sensor device, to estimate the metric of interest when the primary sensor device is not being worn or used, to determine the minimum amount of primary sensor device data needed for train the secondary sensor device, and/or communicate the metric of interest to the user and/or party of interest.

In one embodiment, the primary sensor device comprises at least one pressure-sensing insole or shoe-mounted force sensor configured to measure ground contact forces or in-shoe force. In one preferred embodiment, a pair of pressure-sensing insoles (one in each shoe) is used as the primary sensor device. In other embodiments, the primary sensor device comprised one or more sensors attached on the foot, shank, or other musculoskeletal segments of the user. In other embodiments, the primary sensor device may also contain an inertial measurement unit (IMU), strain gauges, force sensors, motion sensors, electromyography (EMG) electrodes, or sensors integrated into exoskeletons or smart clothing.

In one embodiment, the secondary sensor device comprises a fitness tracker (also termed an activity tracker), which may be worn on a wrist or other part of the body. The fitness tracker may also be in the form of a phone worn in a pocket or elsewhere on the body. The fitness tracker may contain one or more sensors, such IMU, an accelerometer, a gyroscope, a heart rate sensor, a temperature sensor, and a global positioning system (GPS) unit. In other embodiments, the secondary sensor device may comprise a smartphone carried in a pocket, a smartwatch, a ring-style tracker, and/or sensors integrated into clothing or exoskeletons. The secondary sensor device may be configured for continuous wear exceeding 90% of the user's daily activity time. In some embodiments, the secondary sensor device is configured to be worn or used for a time period substantially longer than the primary sensor device; however, the secondary sensor device need not be worn continuously or for a full day. Various types of sensors may be used, including force, pressure, motion, oxygen, sleep, or muscle activity.

In one embodiment, the primary sensor device and the secondary sensor device are integrated into at least one of an insole, shoe or other footwear, a smartwatch, a smartphone, smart clothing, an exoskeleton, or other wearable assistance device.

In one embodiment, the pressure insoles (primary sensor device) are used to estimate musculoskeletal loading on one or more biological tissues (e.g., on the tibia or shank bone, Achilles tendon, calf muscles, ankle joint, knee joint), and a wrist-worn fitness tracker (secondary sensor device) is used to monitor steps, activity level, and/or activity intensity. Nominally, these fitness tracker metrics do not provide direct insight on or estimates of musculoskeletal loading (e.g., on the tibia bone). However, the algorithms detailed herein provide a means of estimating the musculoskeletal loading metric from the fitness tracker, to fill in data gaps when the insoles are not being worn.

In some embodiments, the primary sensor device is collocated on one part of the body, such as the foot, while in other embodiments, the primary sensor device comprises a plurality of sensors located on different parts of the body. In some embodiments, the secondary sensor device is collocated on one part of the body, such as the wrist, while in other embodiments, the secondary sensor device comprises a plurality of sensors located on different parts of the body.

In one embodiment, the model for estimating the metric of interest using the secondary sensor device data is trained by use of a machine learning algorithm, for example, LASSO, gradient boosted tress, neural network, or support vector machine. Alternatively, this model may be trained using regression algorithms or other statistical approaches, or a look-up table may be created.

In some embodiments, the processing unit synchronously collects data from the primary and secondary sensor devices. In other embodiments, the primary and secondary sensor devices have separate processing units that collect (wirelessly or wired) and store data, then data from each sensor system are synchronized and combined separately after data collection.

In one embodiment, the processing unit is further configured to estimate the musculoskeletal loading metric or other metrics of interest using reference data for calibrating or establishing a processing algorithm, wherein the reference data are either stored on data storage means in communication with the processing unit, or collected or inputted from a specific user.

In one embodiment, the processing unit is further configured to alert the user, via audio or vibrotactile feedback, when the musculoskeletal loading or another metric is greater than or less than a threshold that is predetermined or a threshold that is calibrated for a specific user.

In one embodiment, the processing unit is further configured to advise the user on when and how to adjust their movements, actions or physical activity type and duration so as to reduce injury risks, enhance training, or improve recovery.

In one embodiment, the processing unit is further configured to communicate to a computer, a smartphone, a smartwatch, a tablet or other user feedback or data acquisition device for inputting user inputs, and outputting at least one of the estimated biomechanical metrics, and storing the estimated biomechanical metric.

In one embodiment, the processing unit is further configured to estimate a daily tibial bone loading stimulus with less than 10% error when the insoles are worn for at least 25% of a user's daily waking time.

In one embodiment, the processing unit is further configured to compute a daily loading stimulus by summing estimated loading stimuli across a plurality of time intervals, which represents a cumulative musculoskeletal loading measure.

In one embodiment, the processing unit is further configured to store user-specific demographic or physiological data to refine the calibration model.

In one embodiment, the system further comprises a wireless communication interface for transmitting the estimated musculoskeletal loading metrics to a remote device.

In one embodiment, the system further comprises a biofeedback unit in communication with the processing unit for outputting and/or displaying at least one of the biomechanical metrics using audible, visual, tactile, haptic, thermal, electrical or other biofeedback means, and storing the estimated biomechanical metric, alert and advice. In one embodiment, the processing unit is further configured to provide user feedback via an audio, visual, or haptic interface when the musculoskeletal loading metric exceeds a predetermined threshold.

In one embodiment, the biofeedback unit comprises a user interface device for user inputs.

In one embodiment, the user inputs comprise height, weight, body mass index, age, gender, diet, training schedule, subjective pain/fatigue, bone cross-sectional area, bone geometry, bone density, bone composition, GPS position, altitude of the user, and/or other personal health or demographic data.

In one embodiment, the information further comprises data acquired from additional sensors that monitor sleep patterns, heart rate, heart rate variability, rest time between physical activity or other markers of tissue rest or remodeling, or physiological recovery. These measures of rest or recovery can be included, for instance, in more complex models of tissue recovery or injury risk, which include both the processes that damage tissue and processes that stimulate or enable tissues to recover or remodel. This information may come, in part of in whole, from user inputs, or alternatively from sensors within the first or second sensing devices.

In one embodiment, a tissue damage or stimulus metric is estimated by summing across load metrics taken to an exponential power. In other embodiments, a tissue damage or stimulus metric is computed from a more complex function that include at least one biomechanical force or torque input.

In one embodiment, a state machine is used to identify specific activities (e.g., from the primary or secondary sensor devices), and then different algorithms are used to process information and to estimate the biomechanical metrics depending on the current state.

In one embodiment, the biomechanical metrics are computed via real-time or near-real-time estimation algorithms. In other embodiments, the biomechanical metrics are computed are computed at a later time, for instance, at the end of a data collection, or on a daily or weekly basis.

In one embodiment, one or more biomechanical metrics are communicated to the user and/or a party of interest via one or more wireless or wired communication interfaces, either in real-time, near-real-time or at a later time.

In some embodiments, the secondary sensor device is only used to compute a metric of interest if the amount of data collected synchronously with the primary sensor device exceeds a given threshold, for instance, to ensure there is sufficient training data for a given individual, activity, or circumstance in order to achieve a suitably accurate estimate of said metric using only the secondary sensor device.

In some embodiments, there are two or more secondary sensor devices that are trained and provide estimates of the metric of interest.

The method and algorithms and functions described may be implemented in hardware, software, or any combination thereof. If implemented in software, the method and algorithms and functions may be stored on or encoded as one or more instructions or code on a non-transitory tangible computer-readable medium, such that, when the one or more instructions or code are executed by one or more processors, the execution of the one or more instructions or code causes the wearable device to perform a method for musculoskeletal loading on a back segment of a user wearing the wearable device. The non-transitory tangible computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

These and other aspects of the invention are further described below. Without intent to limit the scope of the invention, examples and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example 1

### Using Fitness Tracker Data to Overcome Pressure Insole Wear Time Challenges for Remote Musculoskeletal Monitoring

### Introduction

Each year, over 400,000 Americans experience a tibial shaft fracture, and surgical fixation of the tibia is often necessary. Most surgical fixation surgeries have excellent results in terms of stabilizing the bone, enabling patients to start weight-bearing activities soon after surgery. However, despite advances in surgical techniques, patient recovery 1 year following tibia shaft fixation surgery is often poor and inconsistent, with 65% of patients reporting an inability to perform pre-injury activities. There is converging evidence that it is critical for bone to experience enough loading to stimulate remodeling pathways after a fracture. As such, a key role of clinicians after tibial fracture surgery is to develop and prescribe rehabilitation programs that progressively load the injured bone to stimulate recovery and restore functional abilities.

One limitation of current rehabilitation programs stems from an inability to monitor how patients load their tibia in their daily lives. Patients are seen by clinicians during infrequent check-ups and consultations, leaving most of the patients' daily activity—and associated bone loading—unseen and unknown by clinicians. This blind spot hampers a clinician's ability to create and adapt effective rehabilitation programs and to understand other sources of bone loading in a patient's daily life, or whether patients are being too sedentary to stimulate recovery. There's a need for tools that offer healthcare professionals better insights into patients' daily tibial bone loading, enabling personalized treatment and potentially fostering better care and recovery outcomes.

By integrating wearable sensors and software algorithms, we envision a future of patient care that includes at-home patient monitoring of bone loading. We have previously demonstrated that data from inertial measurement units (IMUs) and pressure insoles (termed insoles, for short) in shoes can be fused in biomechanically informed machine learning algorithms to estimate tibial bone loading within 5% of traditional lab-based estimates. Collectively, we refer to these as wearable sensor systems (hardware and software), and we believe they have the potential to revolutionize patient care by providing clinicians with continuous and personalized data on how patients are loading their tibial bone at home after surgery. However, there are still technical and practical challenges and scientific questions to answer before this vision can be realized.

One of the main challenges impeding the use of wearable sensor systems to remotely monitor bone loading in individuals over multiple days or weeks is the amount of daily sensor wear time. Musculoskeletal recovery and remodeling are dependent on the volume and intensity of tissue loading. However, the amount of tissue loading measured depends on how much time the patient wears the sensors. While a typical adult may be awake for roughly 17 hours per day, previous work observed that patients only wore insoles for between 4-5 hours per day, in part because people do not wear shoes during every waking hour. Furthermore, the insole wear time varied widely day-to-day and between patients. Thus, wearable sensor systems relying on in-shoe insoles are only expected to capture a portion of physical activity and bone loading each day. This challenge is not unique to clinical care or the tibia bone, and in fact, this is a ubiquitous problem of how to account for imperfect (less than 100%) wear time of sensors, due to compliance issues or other practical limitations. There are not currently good solutions to address this issue.

There is a need to develop new methods for wearable sensor systems to obtain more complete, consistent, and comparable estimates of a patient's bone loading across multiple days during remote monitoring, even if wear time varies day to day. Currently, limited or variable amounts of insole wear time can impede our ability to accurately monitor daily accumulated musculoskeletal loading. For instance, if a patient is physically active for 6 hours but only wore insoles for 3 of those hours, then data from the insoles will underrepresent the loading experienced for that day. Now if that same patient were to perform the same amount of physical activity the following day but wore the insoles for the entire 6 hours, then the insoles would report double the loading, even though the loading was the same on both days. This example illustrates the problem we need to address.

Fitness trackers are popular consumer devices that measure physical activity metrics, and while they cannot monitor bone loading, they have the potential for much longer wear times. The high-level metrics from these devices could potentially be used as inputs to train algorithms to extrapolate tibial bone loading during periods when patients are not wearing insoles. Previous research demonstrates encouraging all-day compliance rates of 90% when participants were tasked with daily use of wrist-worn fitness trackers. Fitness trackers use sensors such as inertial measurement units (IMUs), global positional systems (GPS), optical heart sensors, and temperature sensors to monitor various physical activity metrics such as step count, heart rate, activity, and intensity. These metrics provide a high-level view of an individual's activity and have been used to estimate physical activity intensity and energy expenditure. However, we do not yet know how to leverage fitness trackers (e.g., wrist-worn, arm-worn, ring-style) to complement remote musculoskeletal load monitoring derived from insoles or if fitness trackers can help overcome the patient wear time issues with insoles.

The objective of this exemplary study was two-fold. First, we sought to develop a model to estimate tibial bone loading solely from fitness tracker inputs to fill gaps in insole data during remote collections. Second, we aimed to characterize how errors in daily tibial load estimates increase with less insole wear time. The second objective helps inform whether there is a minimum amount of time a person needs to wear insoles each day for effective remote monitoring of tibial bone loading.

### Methods

### Summary

First, we synchronously collected data from in-shoe insoles and a wrist-worn fitness tracker on 8 participants in their daily life. Second, we estimated time-series tibial bone loading (i.e., force) using the insole data and previously published methods.

Third, to address objective 1, we trained a model to estimate tibial loading using only fitness tracker metrics. The specific output from this fitness tracker model was a metric called loading stimulus (LS), which represents the cumulative loading experienced by the tibial bone on a minute-by-minute basis. We then compared the LS estimates from the fitness tracker model to the LS estimates computed from the insole data to evaluate accuracy of our trained model.

We were unable to achieve accurate LS estimates using a generic (participant-independent) model and fitness tracker data. We therefore created a more advanced model with an additional user-specific calibration to reduce LS errors and variability. Throughout the manuscript we refer to these models and their LS outputs as generic and calibrated, respectively.

Fourth, to address objective 2, we built a data-driven simulation for each participant to explore how insole wear time affects the accuracy of daily tibial LS estimates. We summed LS estimates over 9-10 hours per participant to compute a Daily Load Stimulus (DLS) summary metric. We initially used 100% insole data to estimate LS and to represent the best-case scenario of someone wearing their insoles all day. Next, we ran simulations with varying amounts of insole data (e.g., 90% insole data, then 80%, etc.) to represent different insole wear time scenarios. We used the calibrated fitness tracker model to fill gaps in the LS estimates. We then characterized how DLS estimates changed with decreasing insole wear time, relative to the best-case scenario.

### Data Collection

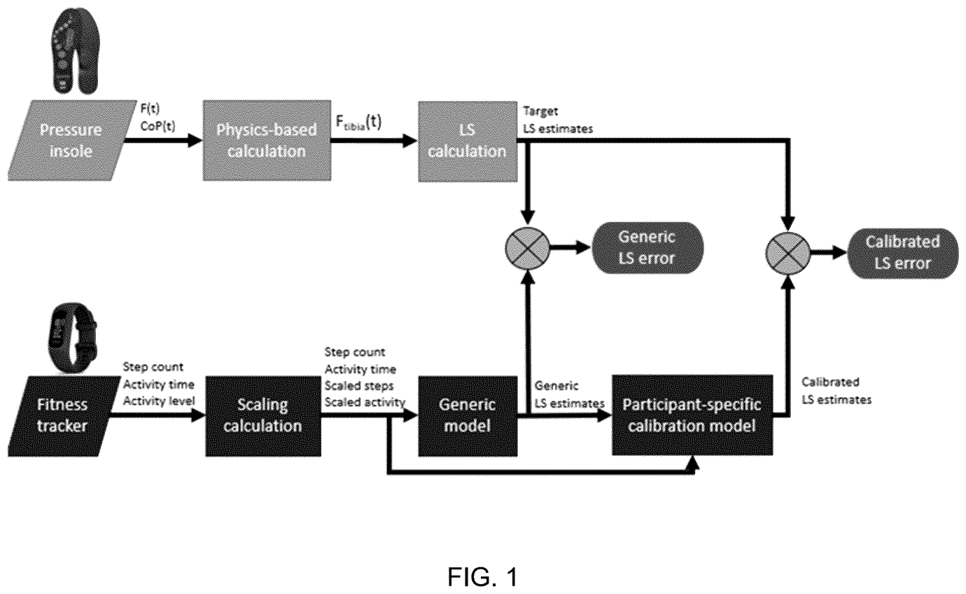

We recruited a convenience sample of 8 participants (4 male, 4 female, aged 21-29 years) to take part in this study, and they provided informed written consent following ethical approval from the Institutional Review Board at Vanderbilt University. We have previously used a similar sample size to develop and demonstrate feasibility of wearable sensor algorithms for musculoskeletal monitoring. We equipped participants with a properly sized insole (Moticon, OpenGo, FIG. 1) in each shoe and a fitness tracker (Garmin Vivosmart 5, FIG. 1) worn on one wrist. Participants wore these sensors for 9-10 hours in their daily life and we instructed participants to go about their normal daily activities and keep their shoes on as much as practical. Participants were also asked to perform a series of exercises in the lab (for about 20 minutes), once in the morning at the start of the data collection and once again in the afternoon. These exercises were representative of rehabilitation exercises commonly performed during tibial fracture recovery. The insoles continuously collected in-shoe pressure data and 6-axis acceleration and gyroscope data from an IMU inside each insole at 25 Hz. The fitness tracker contains several sensors but only exports certain metrics (detailed below) at 0.17 Hz (once per minute).

Calculating Tibial Force from the Insole Data

We calculated time-series tibial compression force (F_{Tibia}(t), also termed loading) of the right leg, using the total force (F(t)) and center of pressure (CoP(t)) from the insoles and previously established physics-based methods (Eqn 1). This insole-based estimate of tibial force was used to compute our target LS for all subsequent processes.

$${F}_{Tibia} ( t ) = F ( t ) + \frac{( CoP ( t ) - x ) \cdot F ( t )}{r} \qquad ( Eqn 1 )$$

Where r is the Achilles tendon moment arm relative to the ankle joint center, assumed to be a constant 5 cm and x is the horizontal distance that we measured from the back of the insole to each participant's ankle joint center when the shoe was flat on the ground.
Objective 1: Developing of a Model to Estimate Tibial Load from Fitness Tracker Data

Model Inputs: Model inputs were computed from the fitness tracker. These metrics included activity time, step count, scaled steps, activity level, and scaled activity. Each metric was extracted on a 1-minute interval using Labfront software (version 1.0.52). These fitness tracker metrics were chosen due to their relevance to movements associated with tibial loading during locomotion. Scaled features involved multiplying the selected signal (i.e., step count or activity time) by the activity level measured by the fitness tracker during the same minute interval. In the Labfront software, activity level was calculated using a proportional integrating method, a measure of activity magnitude or motion vigor, defined as the area under the curve of the accelerometry signal. Activity time is computed as the duration in which the absolute value of the acceleration magnitude from the smart watch exceeded 50 mG.

Model target: We defined LS, a target bone load metric for the model to estimate. LS represents the mechanical stimulus experienced by the tibial over 1 minute. This time interval was selected because the fitness tracker we used only exports metrics once per minute. This exponential relationship was used to reflect how loading stimulates bone healing, using m=4 as the exponent (Eqn 2). There is evidence that load-induced tissue damage stimulates biological remodeling, and that linearly summing loads over time does not accurately reflect the damage experienced. Thus, LS is non-linearly related to tibial force:

$$LS = {( {\int }_{{t}_{a}}^{{t}_{b}} {F}_{Tibia} )}^{m} \qquad ( Eqn 2 )$$

where tₐ and t_{b} are 1-minute apart.

Generic model development: We initially developed a generic model to estimate LS from the fitness tracker metrics. We selected LASSO (Least Absolute Shrinkage and Selection Operator) regression as a suitable approach for developing our model based on prior success using this type of algorithm to estimate tibial bone loading from discrete metrics. The LASSO regression is a technique for statistical modeling and machine learning that uses a least squares model with L1 regularization. This regularization penalizes the sum of the absolute values of the coefficients and forces a subset of learned coefficient weights to zero, helping to build more interpretable models and prevent overfitting. The LASSO model was trained using k-fold cross validation by participant, which means the data from seven participants were used to train the model. The model was then applied to the single participant excluded from the training set. This process was repeated for each participant, resulting in 8 different regressions representing a generic model without any prior knowledge of the individual user.

Participant-specific calibration model: We performed an additional calibration step to better estimate LS from fitness tracker inputs. We created a second LASSO model for each participant. The inputs to this calibration model were the LS estimates from the first LASSO model as well as the fitness tracker metrics. The target was the same LS estimate, computed from the insole.

The LASSO calibration model was trained using a random quarter of the data from that participant and then applied to the rest of the data from that same participant (FIG. 1). This represents a scenario, for instance, where a user worn both their insoles and fitness tracker for 25% of their day, but then for the remaining 75% of the day they only wore the fitness tracker. See Section 2.5 for a deeper analysis of insole wear time effects (i.e., for what happens when different percentages of insole data were used for training this calibration model).

Evaluation: We calculated the coefficient of determination (R²), to evaluate our models and quantify the goodness of fit of each model output to the target LS. R² was calculated between insole estimates of LS (target) and those outputted by the generic and calibrated models for each participant. If R² is negative it means that the model fit is worse than a horizontal line that consistently estimates the average of the target. If the R² is equal to 1 it means that the model output perfectly predicts the target metric.

### Objective 2: Simulating how the Amount of Insole Data Per Day Affects Daily Loading Estimates

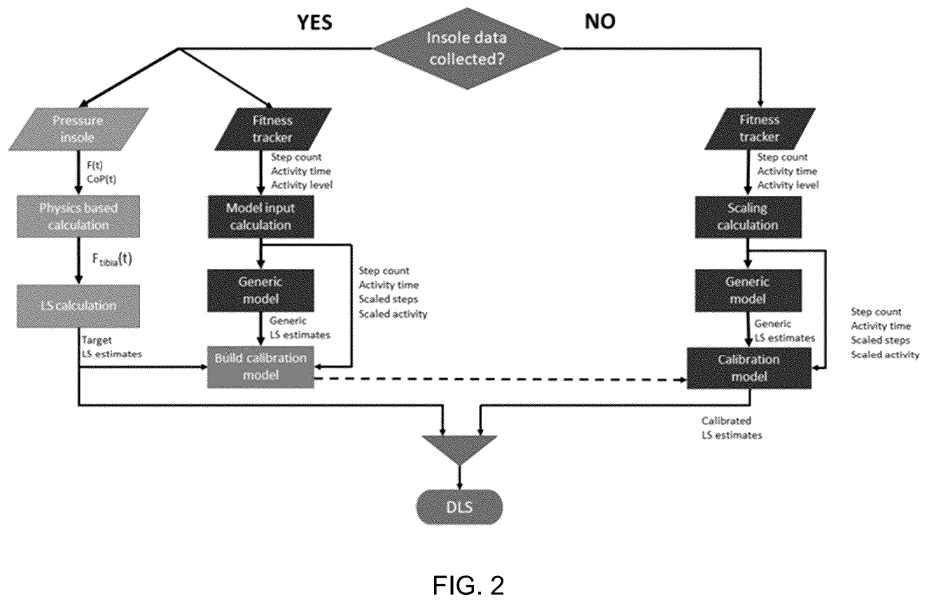

We built a data driven simulation that estimates daily (i.e., cumulative) LS over an entire day. We explored scenarios where insoles were worn only part of the day and the remaining LS estimates were computed using the fitness tracker data and calibrated model, per Section 2.4. LS estimates from periods with insole data were used to train user-specific calibration models. These calibration models were then applied to intervals without insole data to estimate LS using the fitness tracker only (FIG. 2). Finally, we calculated how the percentage of insole data collected each day influenced the daily LS estimated, relative to the best-case scenario of having 100% of the insole data to compute LS.

Daily loading stimulus (DLS): Our long-term goal is to develop and validate a new capability that enables remote monitoring of individuals after tibial shaft fracture surgery (or potentially other lower-limb injuries). We seek to understand how tibial bone loads experienced by patients in daily life influence recovery and how bone loading changes over weeks and months. When looking across multiple days it is useful to define a cumulative summary metric, which we term Daily Load Stimulus (DLS). Daily Load Stimulus is an empirically-derived expression relating tissue damage accumulation and the mechanical stimulus for bone remodeling (Eqn 3-4). For different movement tasks (e.g., walking, running, jumping), the stimulation induced by each task (j) is related to the stress magnitude σⱼ and the number of loading cycles nⱼ (e.g., steps). In some formulations, σⱼ represents the peak stress for a given task (Eqn 3) while in other formulations it represents the time-series or time-integrated stress (i.e., impulse, Eqn 4). Since localized stress in generally impractical to measure in vivo, indicators of stress such tissue force or biomechanical moments are often used as inputs to these expressions. The exponent m in Eqns 3 and 4 reflects the relative contribution of stress magnitude based on animal and cadaver studies, and has typically been assigned a value of 4

$$DLS = {[ {\sum }_{j = 1}^{k} {{n}_{j} ( {σ}_{j} )}^{m} ]}^{\frac{1}{2 m}} \qquad ( Eqn 3 )$$

$$DLS = {[ {\sum }_{j = 1}^{k} {n}_{j} {\int }_{{t}_{f}}^{{t}_{f}} {( {σ}_{j} ( t ) )}^{m} dt ]}^{\frac{1}{2 m}} \qquad ( Eqn 4 )$$

In our analysis, we used the time-integral method (Eqn 4) where every minute of data were treated as a unique, discrete task (j), such that nⱼ was always 1. Furthermore, σⱼ(t) was approximated using F_{Tibia}(t), such that

$${\int }_{{t}_{f}}^{{t}_{f}} {( {σ}_{j} ( t ) )}^{m} dt$$

was equivalent to LSⱼ, yielding Eqn 5 for DLS:

$$DLS = {[ {\sum }_{j = 1}^{k} {LS}_{j} ]}^{\frac{1}{2 m}} \qquad ( Eqn 5 )$$

Simulated days: We simulated 300-400 days for each participant using the empirical data we collected. Each simulated day consisted of the total duration of data collection for each participant in the study (i.e., 9-10 hours). Simulated days varied in the percentage of insole data used and therefore the percentage of the data collection that needed to be filled with fitness tracker estimates of LS. We used an incremental sliding window approach, where the time interval captured inside the window represented the time the participant wore the insoles on that day. We started with a 30-minute window size (i.e., 5% insole data for a 10-hour day) and once a window of a given size moved across the entire day, the size was increased by 5-minutes. For each simulated day, a user-specific calibration model was created based on the insole and fitness tracker data within the sliding window, following the method outlined in Section 2.4.4. This calibration model was then applied to the fitness tracker data outside the sliding window, and the process was repeated for each simulated day.

The DLS from each simulated day was calculated by concatenating the insole LS estimates from inside the sliding window and the fitness tracker LS estimates from the rest of the day (FIG. 2), then applying Eqn 5.

Evaluation: The mean absolute percent error (MAPE) for each simulated day was obtained by comparing the combined fitness tracker and insole DLS to the DLS estimated from only insole data. To summarize the results, the simulated days were categorized into bins based on the percentage of available insole data, with each bin representing a 5% of the day increment (e.g., 0-5%, 5-10%, 10-15%, and so on). For each participant, the average MAPE was calculated within each bin. We then averaged these values across participants to obtain the overall mean and standard deviation for each bin′

### Results

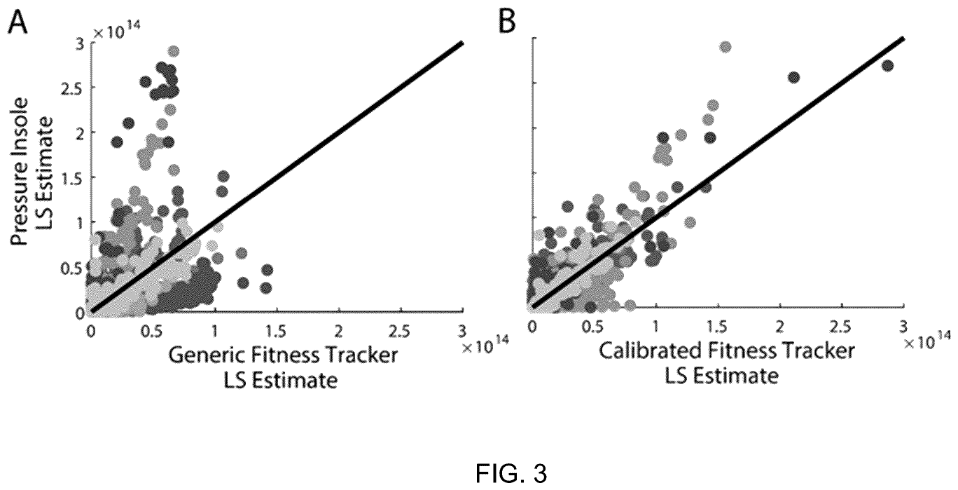

Objective 1: The LS estimates from the generic model showed a poor fit to the target, with an average R² of −1.75 (FIG. 3, Table 1). In contrast, the calibrated LS estimates demonstrated a strong fit, achieving an average R² of 0.76 (FIG. 3, Table 1).

TABLE 1
Coefficient of determination for generic and calibrated
fitness tracker estimates of LS relative to insole estimates of LS.

| | Coefficient of | |
|---|---|---|
| | Determination | |
| Participant | Generic | Calibrated |
| 1 | 0.72 | 0.80 |
| 2 | −0.15 | 0.86 |
| 3 | −6.51 | 0.67 |
| 4 | −6.07 | 0.65 |
| 5 | 0.40 | 0.72 |
| 6 | −3.51 | 0.67 |
| 7 | 0.34 | 0.85 |
| 8 | 0.79 | 0.77 |
| Average | −1.75 ± 0.71 | 0.74 ± 0.06 |

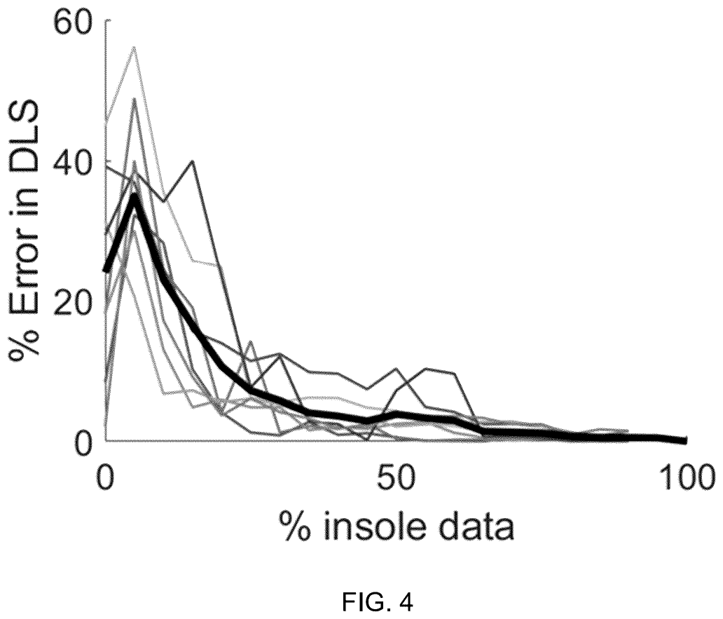

Objective 2: The average error in DLS estimates using only fitness tracker data was 23.1% and varied between about 10-40% across individuals (FIG. 4). This error increases until insole data was used from more than 5% of the day (about 30 minutes), at which point the error began to decrease following a pattern similar to exponential decay. The average error decreased below 10% when insole data from 25% of the day (about 2.5 hours) was included.

### Discussion

We developed a model that estimates tibial bone loading stimulus (LS) directly from fitness tracker metrics to support longitudinal, remote monitoring and help overcome insole wear time challenges. We found that a generic fitness tracker model did not provide accurate estimates of LS (R²=−1.75), but that by adding an easy-to-implement, user-specific calibration we greatly improved LS estimate accuracy (R²=0.76). We then characterized how daily loading stimulus (DLS) estimation accuracy changed with reduced insole wear time. Our results indicated that wearing insoles 25% of the day (e.g., 2.5 out of 10 hours) was sufficient, with the calibrated fitness tracker model, to achieve an average DLS error of under 10%. These findings suggest that a multi-sensor approach—where insoles are worn intermittently, and a fitness tracker is worn continuously throughout the day—could be a viable strategy for long-term, remote monitoring of tibial loading. Below, we discuss the key considerations, potential applications, and limitations of implementing this approach in real-world practices.

### Individual Variability and the Benefits of User-Specific Calibration

Individual behaviors pose a challenge for developing a generic model that uses fitness tracker data to estimate tibial bone loading across different users. We observed substantial variability in fitness tracker metrics between participants during periods of both high and low tibial loading. For instance, participants with smaller arm swings during walking recorded lower activity levels than those with larger arm swings, even when tibial loading was comparable. Similarly, individuals who used a lot of expressive hand gestures during sedentary activities resulted in inflated activity levels, which complicated the identification of true periods of high tibial loading.

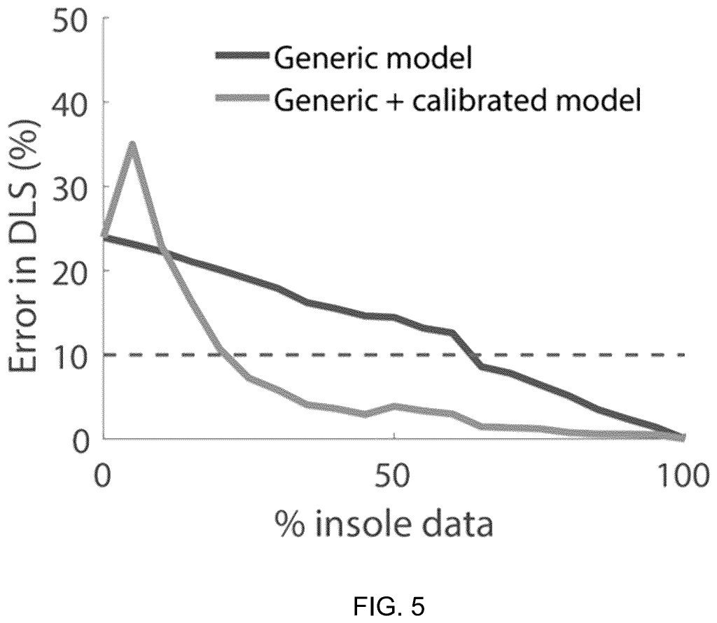

We found user-specific calibrations to be a practical and effective way to improve tibial loading estimates. The key was capturing enough simultaneous data—from both the insoles and the fitness tracker—for each individual that we could model and account for their unique movement patterns (e.g., arm swing magnitude, hand gesture frequency). Importantly, these data can be captured easily during a person's normal daily activities, and without the need for any special tasks or instructions. Without user-specific calibration, insole data from about 60% of the day was needed to achieve less than 10% error in DLS (FIG. 5). However, with the calibration model this decreased to only needing insole data from 25% of the day (FIG. 5). For a 16-hour awake time this is the different between participants needing to wear insoles (and shoes) for almost 10 hours vs. only 4 hours. The former (10 hours) is expected to be prohibitive for many users and use cases, whereas the latter (4 hours) aligns with insole wear time by patients in a previous remote monitoring study. That said, we also observed that if calibrations were performed with very small amounts of insole data, less than one hour, there was not enough loading information to build a robust model, resulting in increased error (FIG. 5). Thus, user-specific calibrations offer a promising solution for practical tibial load monitoring in daily life, but it will be critical that patients wear the pressure insoles for enough time to build accurate calibration models.

### Impacts on Clinical Patient Monitoring

This new approach combines wearable sensors (insoles and fitness trackers) and trained models to obtain more complete daily estimates of bone loading. As discussed in the Introduction, we believe these more complete estimates are critical to obtaining comparable bone loading estimates across multiple days or weeks. This capability could unlock new possibilities for both clinical practice and longitudinal research.

This approach will allow researchers to track tibial loading across extended periods, for instance, throughout recovery from tibial fracture surgery. Previous work has observed 4-5 hours of daily insole wear time, which corresponds to roughly 25-30% of a 16-hour day. With the calibrated model developed in this study, this amount of insole wear time each day would be expected to result in less than 10% error in DLS estimates (FIG. 5). Through the consistent monitoring of daily loading over multiple months during recovery from fracture, researchers can identify patterns and establish benchmarks for the amount of tibial loading that leads to the most favorable outcomes.

We envision that with this approach, clinicians in the future can make more targeted adjustments to rehabilitation plans and optimize exercise regimens or mobility restrictions. Rehabilitation can be personalized and informed by real-world data rather than by infrequent clinic-based evaluations, generic guidelines, or unreliable patient self-reports. The LS estimation model (FIG. 2) developed in this study could provide clinicians with a more comprehensive view of a patient's bone loading patterns during everyday activities. For example, if a patient consistently underloads their tibia during daily activities, clinicians can provide guidance to increase activity safely, while avoiding excessive loading that might cause setbacks in recovery. This remote monitoring approach represents a significant step toward more personalized and data-driven rehabilitation programs.

### Other Monitoring Applications

This study focused on monitoring tibial loading that stimulates bone remodeling after fracture surgery, but the framework could also be adapted for other applications or musculoskeletal tissues. For instance, the same wearable sensors and similarly trained models could be tuned to estimate cumulative damage metrics. These have been used in ergonomic and sports applications to relate musculoskeletal tissue loading to injury risk. Previous research has demonstrated that pressure insoles and IMUs can estimate loading, damage and injury risk in running and ergonomic contexts. However, the real-world implementation of these methods could have a similar issue, ensuring the consistent use of pressure sensing insoles. Fitness trackers more transparent and easier to integrate into daily life and could help facilitate longer form data collections. The fitness tracker gap-filling models presented herein have potential for broad applicability to any insole-based load monitoring that requires full-day or multi-day use.

### Limitations

There are important limitations with the current study, as well as opportunities for future research. First, we collected a convenience sample of 8 participants. This number was informed by previous feasibility studies combining wearable sensors and machine learning to estimate musculoskeletal loads. The results from this study are promising, but still require further investigation to understand generalizability. Second, our participants were all healthy individuals within a similar age range (21-29 years). In clinical populations, factors such as age, physical fitness, immobilizing boots, and altered movement patterns introduce additional complexity. We believe that the development of user-specific calibration models should also work for various patient groups, but further research and validation is warranted for clinical use cases. Third, we only collected a single day of tibial loading data and did not assess the repeatability of our method over multiple days. Clinical interventions for tibial shaft fractures extend over several months, making day-to-day repeatability of these sensors and models an important area for future research. Fourth, we boiled our analysis down to the percentage of the day that insoles are worn. However, it is actually more complicated and there are alternative ways to define minimum insole wear time guidelines. To expound, our simulations indicated that, on average, 2.5 hours of insole data (per 10-hour day) were sufficient to reduce DLS error below 10%. However, the DLS accuracy was more dependent on the type of activity during the hours when insoles were worn than the duration itself. DLS errors from 2.5 hours of insole data ranged from 2.6% to 37.2% across simulated days. For instance, if participants wore the insoles while sitting for 2.5 hours, the resulting calibration model would be inadequate for estimating loading over the rest of the day. From our simulation, 2.5 hours on average contained enough physical activity and loading to build effective calibrations without specific instructions to participants. However, future studies should further assess the repeatability of this method, ideally in the target clinical population. Finally, we only presented results for the right insole. However, we repeated the analysis methods for the left insole, and obtained similar results.

### Conclusions

We developed and evaluated a method for estimating tibial load using a fitness tracker. Eight participants wore pressure insoles and a fitness tracker during a 10-hour remote data collection. We found that trained models could accurately estimate tibial loading stimulus—the weighted impulse of tibial load—every minute with high accuracy (R²=0.74) when user-specific calibration models were used. A data-driven simulation estimated daily loading stimulus—the accumulation of loading stimulus over the course of the day, raised to an empirically derived exponent—revealed that wearing the insole for just 25% of the day was sufficient to achieve an average error of under 10%. These results suggest that a wrist-worn fitness tracker, combined with trained models, can effectively supplement pressure insoles for remote monitoring of tibial bone loading.

We found that a wrist-worn fitness tracker coupled with trained models can effectively and practically supplement remote monitoring of tibial bone load with insoles, helping to overcome insole wear time challenges.

### Example 2

### Additional Algorithms

### Algorithm 1: Generic Plus User-Specific Model

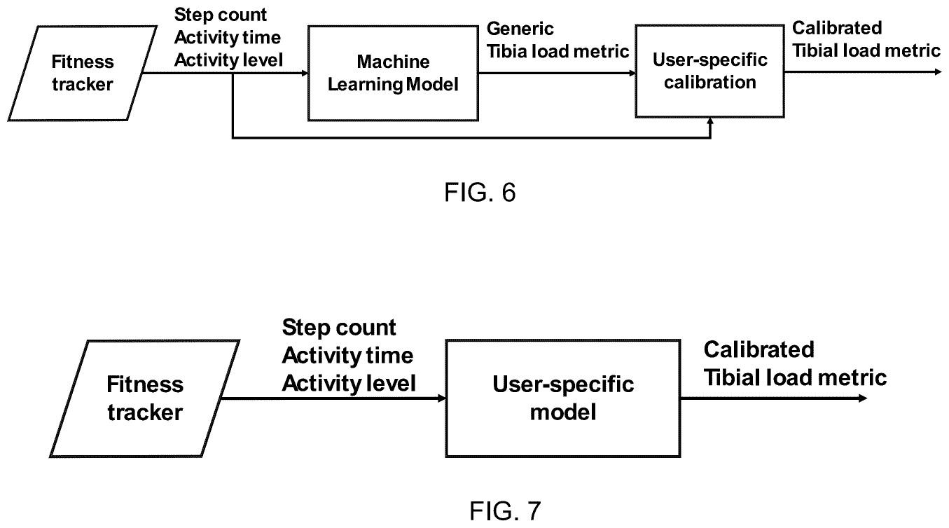

FIG. 6 shows schematically a flowchart of an algorithm for a generic machine learning model and a user-specific model. Calculated metrics from a fitness tracker are inputted to the generic machine learning model (i.e., trained on other people) to estimate tibia loading or other biomechanical or musculoskeletal metrics. A user-specific calibration is built based on the data collected during the day when users are wearing both insoles (and/or other wearable sensors) and fitness trackers (e.g., activity monitors, smartwatches, phones).

### Algorithm 2: User-Specific Model Only

FIG. 7 shows schematically a flowchart of an algorithm for a user-specific model only. We can remove the generic machine learning model and just implement a user-specific approach where a user-specific model is built based on the data collected during the day when users are wearing both insoles (and/or other wearable sensors) and fitness trackers.

Algorithm 3: Classifier with Look-Up Table

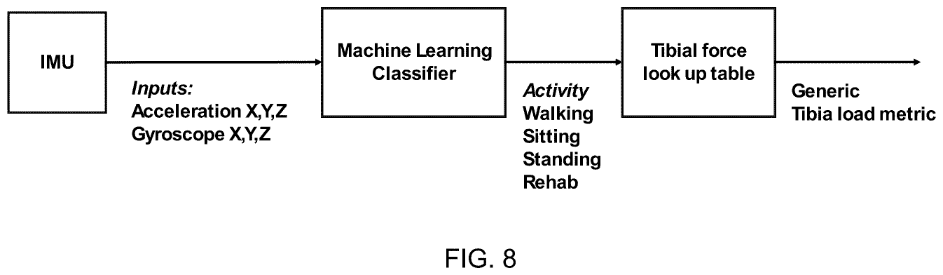

FIG. 8 shows schematically a flowchart of an algorithm for classifier with look-up table. This method can use an IMU (e.g., in a fitness tracker, activity tracker, smartwatch, phone) to identify what activity is being performed during a specified time window and use a predefined look-up table to estimate the tibia loading (or other biomechanical or musculoskeletal metrics) from that time window.

The generic output metric could be used as-is, or further calibrated via a user-specific model (such as in prior algorithms) or via other means.

### Algorithm 4: Hybrid Approach

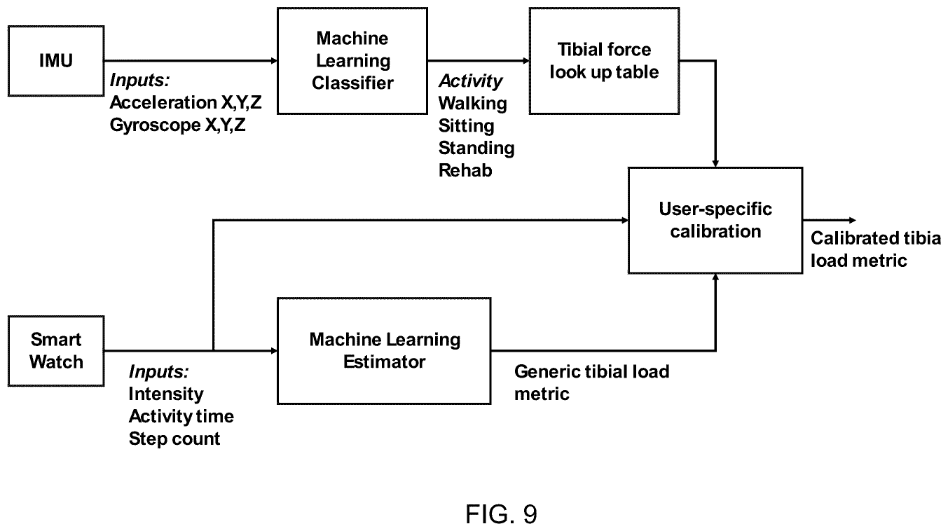

FIG. 9 shows schematically a flowchart of an algorithm for hybrid approach. We can build both a classifier (top track) and a regression/ML model (bottom track) on other people's data, then use a fusion model or user-specific calibration model to refine estimates of loading to the user. This calibration could, for instance, include an additional look-up table based on previously recorded tibial loading for this individual or it may be based on the data collected during the day when users are wearing both insoles (and/or other wearable sensors) and fitness trackers.

These algorithms and flow diagrams, including the specific metrics listed, are exemplary and alternative embodiments may contain more or fewer blocks, or various other rearrangements or metrics.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of the invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### REFERENCES

[1]. Antonova E, Le T K, Burge R, Mershon J. Tibia shaft fractures: costly burden of nonunions. BMC Musculoskelet Disord. 2013; 14:42. doi: 10.1186/1471-2474-14-42.
[2]. Madadi F, Eajazi A, Madadi F, Besheli L D, Sadeghian R, Lari M N. Adult tibial shaft fractures—different patterns, various treatments and complications. Med Sci Monit. 2011; 17(11):CR640-CR645. doi: 10.12659/MSM.882049.
[3]. Busse J W, Morton E, Lacchetti C, Guyatt G H, Bhandari M. Current management of tibial shaft fractures: a survey of 450 Canadian orthopedic trauma surgeons. Acta Orthop. 2008; 79(5):689-694. doi: 10.1080/17453670810016722.
[4] Gross S C, Galos D K, Taormina D P, Crespo A, Egol K A, Tejwani N C. Can Tibial Shaft Fractures Bear Weight After Intramedullary Nailing? A Randomized Controlled Trial. J Orthop Trauma. 2016; 30(7):370-375. doi: 10.1097/BOT.0000000000000598.
[5]. Schmidt A H, Finkemeier C G, Tornetta P. Treatment of closed tibial fractures. Instr Course Lect. 2003; 52:607-622.
[6]. Larsen P, Elsoe R, Hansen S H, Graven-Nielsen T, Laessoe U, Rasmussen S. Incidence and epidemiology of tibial shaft fractures. Injury. 2015; 46(4):746-750. doi: 10.1016/j.injury.2014.12.027.
[7]. Trickett R W, Mudge E, Price P, Pallister I. A qualitative approach to recovery after open tibial fracture: the road to a novel, patient-derived recovery scale. Injury. 2012; 43(7):1071-1078. doi: 10.1016/j.injury.2012.01.027.
[8]. Ferguson M, Brand C, Lowe A, et al. Outcomes of isolated tibial shaft fractures treated at level 1 trauma centres. Injury. 2008; 39(2):187-195. doi: 10.1016/j.injury.2007.03.012.
[9]. Goodman C A, Hornberger T A, Robling A G. Bone and Skeletal Muscle: Key Players in Mechanotransduction and Potential Overlapping Mechanisms. Bone. 2015; 80:24-36. doi: 10.1016/j.bone.2015.04.014.
[10]. Davis K M, Griffin K S, Chu T G, et al. Muscle-bone interactions during fracture healing. J Musculoskelet Neuronal Interact. 2015; 15(1):1-9.
[11]. Larsen P, Elsoe R, Laessoe U, Graven-Nielsen T, Eriksen C B, Rasmussen S. Decreased QOL and muscle strength are persistent 1 year after intramedullary nailing of a tibial shaft fracture: a prospective 1-year follow-up cohort study. Arch Orthop Trauma Surg. 2016; 136(10):1395-1402. doi: 10.1007/s00402-016-2537-2.
[12]. Matijevich E S, Scott L R, Volgyesi P, Derry K H, Zelik K E. Combining wearable sensor signals, machine learning and biomechanics to estimate tibial bone force and damage during running. Hum Mov Sci. 2020; 74:102690. doi: 10.1016/j.humov.2020.102690.
[13]. Elstub L J, Nurse C A, Grohowski L M, Volgyesi P, Wolf D N, Zelik K E. Tibial bone forces can be monitored using shoe-worn wearable sensors during running. J Sports Sci. 2022; 40(15):1741-1749. doi: 10.1080/02640414.2022.2107816.
[14]. Burr D B, Martin R B, Schaffler M B, Radin E L. Bone remodeling in response to in vivo fatigue microdamage. J Biomech. 1985; 18(3):189-200. doi: 10.1016/0021-9290(85)90204-0.
[15]. Chamay A, Tschantz P. Mechanical influences in bone remodeling. Experimental research on Wolff's law. J Biomech. 1972; 5(2):173-180. doi: 10.1016/0021-9290(72)90053-x.
[16]. Coutrot A, Lazar A S, Richards M, et al. Reported sleep duration reveals segmentation of the adult life-course into three phases. Nat Commun. 2022; 13(1):7697. doi: 10.1038/s41467-022-34624-8.
[17]. Abbott C A, Chatwin K E, Foden P, et al. Innovative intelligent insole system reduces diabetic foot ulcer recurrence at plantar sites: a prospective, randomised, proof-of-concept study. Lancet Digit Health. 2019; 1(6):e308-e318. doi: 10.1016/S2589-7500(19)30128-1.
[18]. Speier W, Dzubur E, Zide M, et al. Evaluating utility and compliance in a patient-based eHealth study using continuous-time heart rate and activity trackers. J Am Med Inform Assoc. 2018; 25(10):1386-1391. doi: 10.1093/jamia/ocy067.
[19]. Semaan S, Dewland T A, Tison G H, et al. Physical activity and atrial fibrillation: Data from wearable fitness trackers. Heart Rhythm. 2020; 17(5, Part B): 842-846. doi: 10.1016/j.hrthm.2020.02.013.
[20]. Morris C E, Wessel P A, Tinius R A, Schafer M A, Maples J M. Validity of Activity Trackers in Estimating Energy Expenditure During High-Intensity Functional Training. Research Quarterly for Exercise and Sport. 2019; 90(3):377-384. doi: 10.1080/02701367.2019.1603989.
[21]. LaMunion S R, Blythe A L, Hibbing P R, Kaplan A S, Clendenin B J, Crouter S E. Use of consumer monitors for estimating energy expenditure in youth. Appl Physiol Nutr Metab. 2020; 45(2):161-168. doi: 10.1139/apnm-2019-0129.
[22]. Matijevich E S, Volgyesi P, Zelik K E. A Promising Wearable Solution for the Practical and Accurate Monitoring of Low Back Loading in Manual Material Handling. Sensors (Basel). 2021; 21(2):340. doi: 10.3390/s21020340.
[23]. Nurse C A, Elstub L J, Volgyesi P, Zelik K E. How Accurately Can Wearable Sensors Assess Low Back Disorder Risks during Material Handling? Exploring the Fundamental Capabilities and Limitations of Different Sensor Signals. Sensors. 2023; 23(4):2064. doi: 10.3390/s23042064.
[24]. Hullfish T J, Baxter J R. A simple instrumented insole algorithm to estimate plantar flexion moments. Gait Posture. 2020; 79:92-95. doi: 10.1016/j.gaitpost.2020.04.016.
[25]. Ancoli-Israel S, Cole R, Alessi C, Chambers M, Moorcroft W, Pollak C P. The role of actigraphy in the study of sleep and circadian rhythms. Sleep. 2003; 26(3):342-392. doi: 10.1093/sleep/26.3.342.
[26]. Fekedulegn D, Andrew M E, Shi M, Violanti J M, Knox S, Innes K E. Actigraphy-Based Assessment of Sleep Parameters. Ann Work Expo Health. 2020; 64(4):350-367. doi: 10.1093/annwch/wxaa007.
[27]. Turner C H. Three rules for bone adaptation to mechanical stimuli. Bone. 1998; 23(5):399-407. doi: 10.1016/s8756-3282(98)00118-5.
[28]. Carter D R, Fyhrie D P, Whalen R T. Trabecular bone density and loading history: regulation of connective tissue biology by mechanical energy. J Biomech. 1987; 20(8):785-794. doi: 10.1016/0021-9290(87)90058-3.
[29]. Firminger C R, Asmussen M J, Cigoja S, Fletcher J R, Nigg B M, Edwards W B. Cumulative Metrics of Tendon Load and Damage Vary Discordantly with Running Speed. Med Sci Sports Exerc. 2020; 52(7):1549-1556. doi: 10.1249/MSS.0000000000002287.
[30]. Aviral Gupta, Akshay Sharma, Dr. Amita Goel, Maharaja Agrasen Institute of Technology/Guru Gobind Singh Indraprastha University. Review of Regression Analysis Models. IJERT. 2017; V6(08):IJERTV6IS080060. doi: 10.17577/IJERTV6IS080060.
[31]. Halilaj E, Rajagopal A, Fiterau M, Hicks J L, Hastie T J, Delp S L. Machine learning in human movement biomechanics: Best practices, common pitfalls, and new opportunities. J Biomech. 2018; 81:1-11. doi: 10.1016/j.jbiomech.2018.09.009.
[32]. Whalen R T, Carter D R, Steele C R. Influence of physical activity on the regulation of bone density. J Biomech. 1988; 21(10):825-837. doi: 10.1016/0021-9290(88)90015-2.
[33]. Cavanagh P R, Gopalakrishnan R, Rice A J, et al. An ambulatory biomechanical data collection system for use in space: design and validation. Aviat Space Environ Med. 2009; 80(10):870-881. doi: 10.3357/asem.2266.2009.
[34]. Genc K O, Humphreys B T, Cavanagh P R. Enhanced daily load stimulus to bone in spaceflight and on earth. Aviat Space Environ Med. 2009; 80(11):919-926. doi: 10.3357/asem.2380.2009.
[35]. Edwards W B. Modeling Overuse Injuries in Sport as a Mechanical Fatigue Phenomenon. Exerc Sport Sci Rev. 2018; 46(4):224-231. doi: 10.1249/JES.0000000000000163.
[36]. Carter D R, Caler W E. A cumulative damage model for bone fracture. J Orthop Res. 1985; 3(1):84-90. doi: 10.1002/jor.1100030110.
[37]. Currey J. Bones: Structure and Mechanics. Princeton Press; 2013.
[38]. Gallagher S, Schall M C. Musculoskeletal disorders as a fatigue failure process: evidence, implications and research needs. Ergonomics. 2017; 60(2):255-269. doi: 10.1080/00140139.2016.1208848.

What is claimed is:

1. A method for monitoring musculoskeletal loading of a user, comprising:
collecting and/or computing, by a primary sensor device operably attached to the user, primary sensor data indicative of musculoskeletal loading of the user, wherein the primary sensor device comprises at least one of a pressure sensor and a force sensor;
collecting and/or computing, by a secondary sensor device operably attached to the user, secondary sensor data indicative of physical activity of the user, wherein the secondary sensor device comprises at least one inertial measurement unit sensor;
synchronizing the primary sensor data with the secondary sensor data over at least one training interval;
training, using the synchronized primary and secondary sensor data, a calibration model specific to the user to estimate a musculoskeletal loading from the secondary sensor data; and
estimating, by applying the calibration model, the musculoskeletal loading during a period in which only the secondary sensor data is available.

2. The method of claim 1, wherein the primary sensor device comprises at least one of a pressure-sensing insole and a shoe-mounted force sensor configured to measure ground reaction forces or in-shoe forces.

3. The method of claim 1, wherein the primary sensor device further comprises at least one inertial measurement unit.

4. The method of claim 1, wherein the secondary sensor device comprises at least one fitness tracker, smartwatch, smart ring, or phone configured to measure at least one of step count, activity time, activity level, accelerometry, heart rate, and/or motion intensity.

5. The method of claim 1, wherein said synchronizing the primary sensor data with the secondary sensor data comprises wirelessly collecting data with timestamps from the primary and secondary sensor devices and aligning the timestamped data streams in time, or wherein the primary sensor data and secondary sensor data are used to compute step count or movement intensity metrics that are aligned via correlational or convolutional methods.

6. The method of claim 1, wherein said training comprises applying a machine learning algorithm including LASSO (least absolute shrinkage and selection operator) regression, gradient boosted trees, neural networks, and/or support vector machines.

7. The method of claim 1, wherein said estimating further comprises supplementing missing primary sensor data with estimated metrics derived from the secondary sensor device.

8. The method of claim 1, wherein the calibration model is a user-specific calibration model that is built based on the synchronized primary and secondary sensor data.

9. The method of claim 1, wherein the calibration model is retrained periodically using new synchronized primary and secondary data collected during subsequent use.

10. The method of claim 1, wherein the musculoskeletal loading metric comprises a tibial bone loading stimulus computed as a function of time-integrated tissue force raised to an exponent, or wherein the musculoskeletal loading metric comprises a bone, muscle, or tendon force, damage, or stimulus metric, or a joint force, moment, or power.

11. The method of claim 10, wherein the tibial bone loading stimulus is estimated with less than 10% error when the pressure insoles are worn for at least 25% of a user's daily waking time.

12. The method of claim 1, further comprising providing user feedback through an audio, visual, and/or haptic interface in real time when the musculoskeletal loading metric exceeds a predetermined threshold.

13. The method of claim 1, further comprising computing a daily loading stimulus by summing estimated loading stimuli across a plurality of intervals of a day, which represents a cumulative musculoskeletal loading measure.

14. A wearable sensor system for monitoring musculoskeletal loading of a user, comprising:
a primary sensor device comprising one or more sensors operably attached to a first location of the user, the primary sensor device comprising at least one of a pressure sensor and a force sensor, the primary sensor device configured to generate primary sensor data indicative of a musculoskeletal loading metric;
a secondary sensor device comprising one or more sensors operably attached to a second location of the user, the primary sensor device comprising at least one inertial measurement unit sensor, the secondary sensor device configured to generate secondary sensor data indicative of physical activity of the user; and
at least one processing unit in communication with the primary and secondary sensor devices, the processing unit configured to:
synchronize the primary sensor data with the secondary sensor data;
train a calibration model using the synchronized primary and secondary sensor data to estimate the musculoskeletal loading metric from the secondary sensor data; and
apply the calibration model to estimate the musculoskeletal loading metric during one or more periods in which only the secondary sensor device provides data.

15. The system of claim 14, wherein the primary sensor device comprises at least one of a pressure-sensing insole and a shoe-mounted force sensor configured to measure ground reaction forces or in-shoe forces.

16. The system of claim 14, wherein the primary sensor device further comprises at least one inertial measurement unit.

17. The system of claim 14, wherein the primary sensor device further comprises strain gauges, force sensors, motion sensors, electromyography (EMG) electrodes, or sensors integrated into exoskeletons or smart clothing.

18. The system of claim 14, wherein the first location of the user includes the foot or leg of the user.

19. The system of claim 14, wherein the secondary sensor device comprises at least one fitness tracker, smartwatch, smart ring, phone, and/or sensors integrated into clothing or exoskeletons.

20. The system of claim 19, wherein the secondary sensor device is configured to measure at least one of step count, activity time, activity level, acceleration, angular velocity, heart rate, temperature, global positioning, and/or motion intensity.

21. The system of claim 14, wherein the secondary sensor device is configured for continuous wear during the majority of the user's daily activity time.

22. The system of claim 14, wherein the primary sensor device and the secondary sensor device are integrated into at least one of an insole, smart clothing, and an exoskeleton.

23. The system of claim 14, wherein the calibration model is a user-specific calibration model that is built based on the synchronized primary and secondary sensor data.

24. The system of claim 14, wherein the calibration model comprises a machine learning algorithm including regression models, decision tree models, neural networks, and/or support vector machines.

25. The system of claim 14, wherein the processing unit is further configured to estimate a daily tibial bone loading stimulus with less than 10% error when the insoles are worn for at least 25% of a user's daily waking time.

26. The system of claim 14, wherein the processing unit is further configured to provide user feedback via an audio, visual, or haptic interface when the musculoskeletal loading metric exceeds a predetermined threshold.

27. The system of claim 14, wherein the processing unit is further configured to compute a daily loading stimulus by summing estimated loading stimuli across a plurality of time intervals, which represents a cumulative musculoskeletal loading measure.

28. The system of claim 14, wherein the processing unit is further configured to store user-specific demographic or physiological data to refine the calibration model.

29. The system of claim 14, further comprising a wireless communication interface for transmitting the estimated musculoskeletal loading to a remote device.

30. A non-transitory tangible computer-readable storage medium storing instructions that, when executed by a processing unit, cause the processing unit to perform the method for monitoring musculoskeletal loading of a user during remote or longitudinal activity according to claim 1.
